(19) United States
(12) Patent Application Publication
(10) Pub. No.: US 2015/0342184 A1
(43) Pub. Date: Dec. 3, 2015

(54) SLEEVES AND THE LIKE HAVING ANTI-MICROBIAL PROPERTIES FOR USE IN RESTAURANTS AND OTHER PUBLIC AND PRIVATE FACILITIES

(71) Applicants: Craig M. Miller, Las Vegas, NV (US); William Lastra, Las Vegas, NV (US); Chancellor J. Lastra, Las Vegas, NV (US)

(72) Inventors: Craig M. Miller, Las Vegas, NV (US); William Lastra, Las Vegas, NV (US); Chancellor J. Lastra, Las Vegas, NV (US)

(21) Appl. No.: 14/727,557

(22) Filed: Jun. 1, 2015

Related U.S. Application Data
(60) Provisional application No. 62/005,806, filed on May 30, 2014.

(51) Int. Cl. A01N 25/34; A01N 25/10

(52) U.S. Cl. CPC A01N 25/34; A01N 25/10

(57) ABSTRACT

Sleeves, menus, tablecloths, pens, door push covers and other restaurant-type articles having anti-microbial properties to prevent the passage of microorganisms. Sleeves may be used with condiment containers, pens, door knobs, menus, chair arms, door pushes, etc. The articles herein are fabricated of a material impregnated with anti-microbial chemicals and/or compounds. The material is also non-absorbent (i.e., water resistant) allowing the articles to be wiped clean using conventional commercial cleaning agents. Materials used for fabricating tablecloths, for example, may have fibers impregnated with anti-microbial chemical and/or chemicals. Impregnating a material with one or more anti-microbial chemicals and/or compounds results in a material having the following properties: (i) water resistant; (ii) flexible and (iii) microorganism resistant.

### CROSS-REFERENCE

This application claims priority to U.S. Patent Application No. 62/005,806 filed May 30, 2015 and which is incorporated herein for any and all purposes.

### FIELD OF THE INVENTION

The embodiments of the present invention relate to menus and condiment, pen, arm chair and door knob sleeves configured to slow down or prevent the passage of bacteria and viruses from person-to-person.

### BACKGROUND

Condiments and spices are ubiquitous on restaurant counters and tables. Generally, the condiments and spices are held in self-dispensing containers such as salt and pepper shakers. Others include ketchup, mustard, crushed red peppers and hot sauce dispensers. In most instances, the condiments and spice dispensers are made of plastic or glass. Menus are also ubiquitous and typically handled by every patron.

The problem with both dispensers and menus is they are handled during the dining experience by almost every customer. This high frequency of handling dispensers and menus poses a health risk to every dinner coming in contact with the same. Microorganisms are always present on people's hands. Some are harmless but others can pose a health risk. For example, a customer may be afflicted by a viral or bacterial illness. Their hands provide an ideal carrier of these pathogens. This microorganism contamination can be transferred from a dinners' hand to a dispenser and from that dispenser to each subsequent dinner as long as the pathogens remain active.

Other commonly handled items in a restaurant include chair arms, door knobs and pens.

It would be advantageous to develop sleeves and materials for slowing or preventing the passage of microorganisms from person to person via condiment containers and other restaurant articles.

### SUMMARY

In one embodiment, a condiment container sleeve is configured to fit on the subject condiment container (e.g., salt, pepper, ketchup, etc.). The condiment container sleeve is manufactured of a plastic compound impregnated with anti-microbial chemicals. The anti-microbial condiment container sleeves may be made of any non-absorbent, flexible polymer or plastic type material such as polyester, polyethylene, PVC, Kydex, polymers, etc. Other synthetic and natural materials can be used individually or in combination as well. Advantageously, the non-absorbent condiment container sleeve can be wiped clean easily using conventional commercial cleaning supplies. Impregnating the polymer or plastic material with anti-microbial chemicals rather than applying a surface coating only is more permanent and stable. Such a design eliminates or reduces the ability for microorganisms to attach, live and grow on the surface of a dispenser.

The embodiments of the present invention also involve sleeves for pens, chair arms, door knobs and menus. As suggested above, the articles may also be fabricated of a material resistant to microorganisms. In another embodiment, fibers of a material are impregnated with anti-microbial chemicals and/or compounds rendering the resultant material resistant to microorganisms. A table cloth is a suitable article to fabricate from such a fiber-based material.

According to WebMD in an article entitled “Flu Prevention Strategies” when in a restaurant “you can pick up the flu virus from touching a surface—where a sick person dined before you. Flu germs can linger on surfaces for up to eight hours.” The embodiments of the present invention seek to solve this passage of microorganisms from diner to diner.

Other variations, embodiments and features of the present invention will become evident from the following detailed description, drawings and claims.

### BRIEF DESCRIPTION OF THE DRAWINGS

FIGS. 1A-1B illustrate various views of condiment container sleeves in use and a menu according to the embodiments of the present invention;

FIG. 2 illustrates a chair sleeve according to the embodiments of the present invention;

FIGS. 3A and 3B illustrate a chair sleeve according to the embodiments of the present invention;

FIGS. 4A-4C illustrate a door knob and door knob sleeve according to the embodiments of the present invention;

FIGS. 5A and 5B illustrate a menu sleeve according to the embodiments of the present invention; and

FIGS. 6A-6D illustrate door pushes according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to those skilled in the relevant art and having possession of this disclosure, are to be considered within the scope of the invention claimed.

The passage of microorganisms from condiment containers, pens, chairs, door knobs, menus and table cloths to diners is a common problem. One solution is to have service staff wipe the articles and menus after each service. Unfortunately, such a process is time consuming and raises the possibility of contaminated cleaning rags. Another solution is to spray the articles with a liquid disinfectant. Unfortunately, such disinfectants often have odors that are unpleasant in a dinning environment and may pose problems over time.

Not only can the condiment containers, pens, chairs, door knobs, menus and table cloths carry bacteria and microorganisms, they also become soiled over time. Diners' hands can become contaminated with food matter, such as grease, oil, sauces, condiments, etc. These contaminants can then be transferred from hands to condiment containers, pens, chairs, door knobs, menus and table cloths or splashed directly thereon during the dining process. This soiling can render the articles visually unsightly and tactilely repulsive to the diners' touch. Many factors contribute to a diner's perception of the cleanliness of a restaurant including the general appearance of the establishment. Coming in physical contact with objects that are obviously “unclean” is disturbing too many. Most people prefer to dine at restaurants perceived to be clean and it is unpleasant to handle condiment containers, pens, chairs, door knobs, menus and table cloths that are sticky or tacky to the touch.

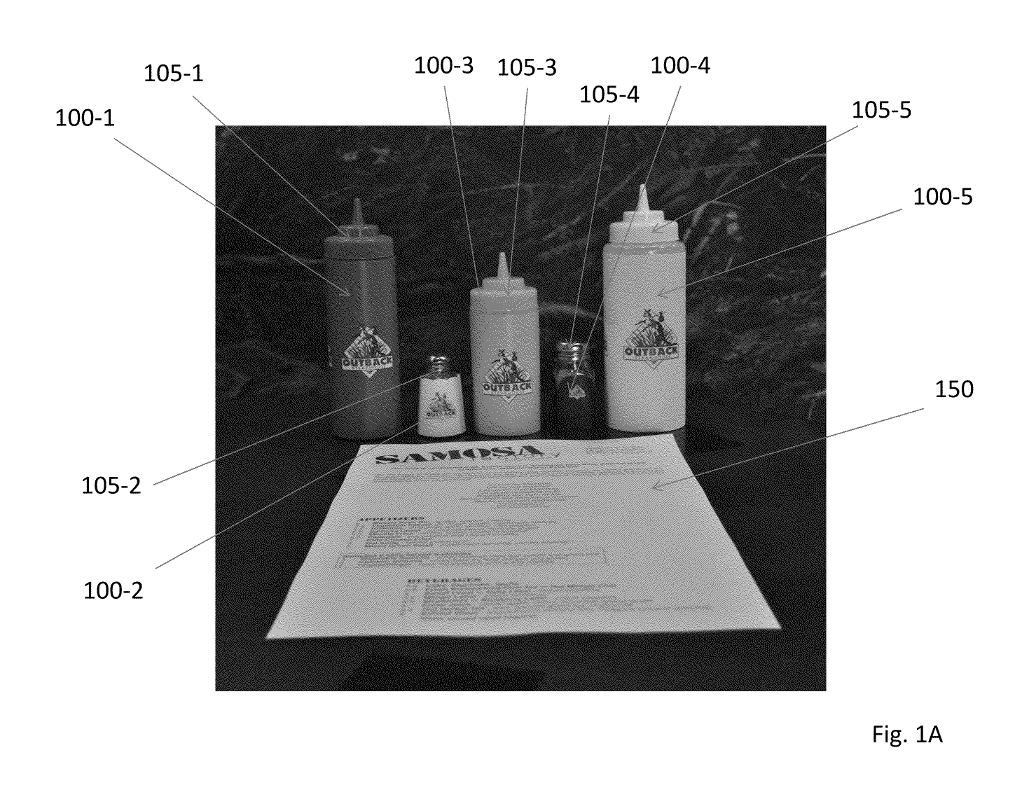

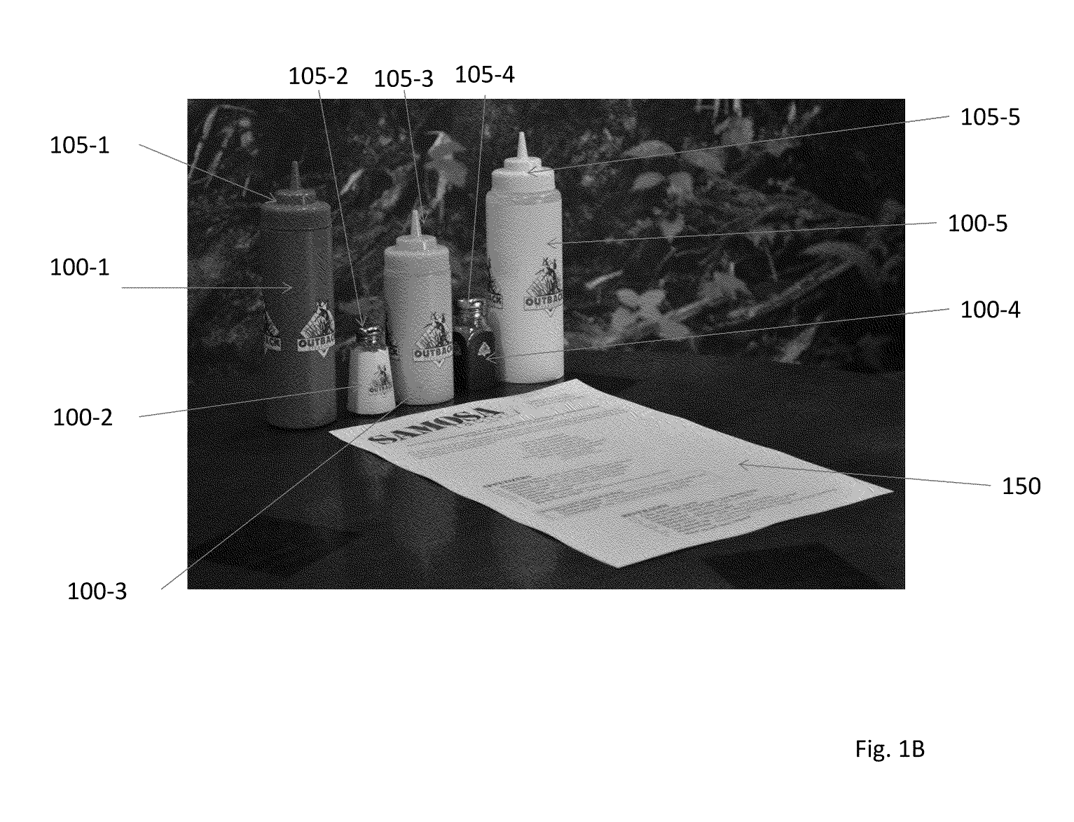

FIGS. 1A-1B show various views of condiment container sleeves 100-1 through 100-5 according to the embodiments of the present invention. The sleeves 100-1 through 100-5 are tubular members configured to fit over the condiment containers 105-1 through 105-5 comprising ketchup, salt, mustard, pepper and mayonnaise. Friction holds the closed (or open) condiment container sleeves 100-1 through 100-5 in place on the condiment containers 105-1 through 105-5. In other embodiments, adhesives may be used to hold the sleeves 100-1 through 100-5 in place. The condiment container sleeves 100-1 through 100-5 are fabricated of materials known to repel microorganisms including bacteria, viruses, fungi and algae. In one embodiment, the condiment container sleeves 100-1 through 100-5 are fabricated of polyester, silicon elastomers, PVC and other polymer and plastic type materials impregnated with one or more anti-microbial chemicals. Such materials are flexible and may be wiped clean of soiling using conventional cleaning agents. While the condiment containers shown correspond to a squeeze ketchup container 105-1, salt shaker 105-2, squeeze mustard container 105-3, pepper shaker 105-4 and squeeze mayonnaise container 105-5, it is understood that sleeves for other condiment containers including, but not limited to hot sauce, salsa, relish and the like are covered by the embodiments of the present invention.

As shown, the sleeves 100-1 through 100-5 are formed with logos corresponding to the restaurant in which the condiments are served. Moreover, the condiments sleeves 100-1 through 100-5 are colored to indicate the condiment type. In another embodiment, the condiment sleeves 100-1 through 100-5 are transparent to allow the condiment label to remain visible.

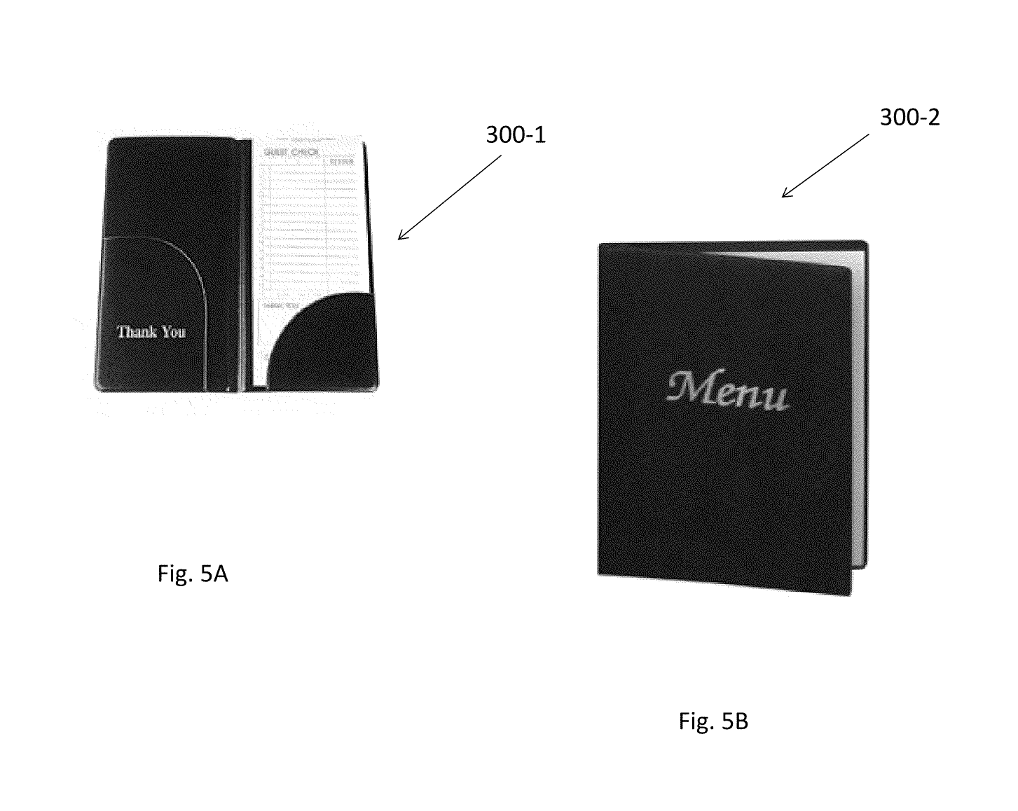

In another embodiment, shown in FIGS. 1A, 1B, 5A and 5B, menus 150, 300-1 and 300-2 are also fabricated of plastic type materials impregnated with anti-microbial chemicals known to repel microorganisms including bacteria, viruses, fungi and algae. The menu 150 may be a single sheet style menu or a booklet-style menu 300-1, 300-2. Like the condiment container sleeves 100-1 through 100-5, the menus and/or their covers are flexible and may be wiped cleaned.

Now referring to FIG. 2, a chair arm sleeve 200 is configured to be placed on the arms 205 of a chair 210. As shown, the chair arm sleeve 200 is C-shaped (i.e., open tubular) and fits over the chair arms 205. In other embodiments, the chair arm sleeves may take on other shapes (e.g., closed tube akin to the condiment container sleeves 100-1 through 100-5) and configurations to accommodate other arm chair arm shapes. In this instance, the chair arm sleeve 200 may be attached to the chair via friction, straps, snaps, ties, hook and loop fasteners, etc. The sleeve 200 may be made of a flexible material or like the tablecloth described below, a cloth material.

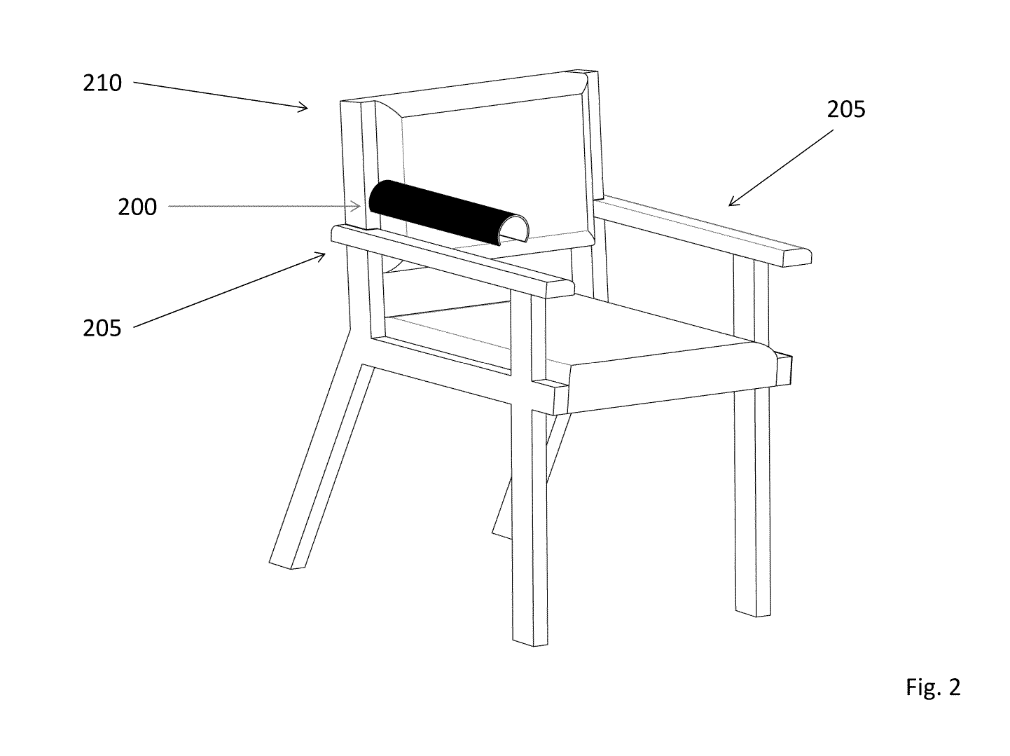

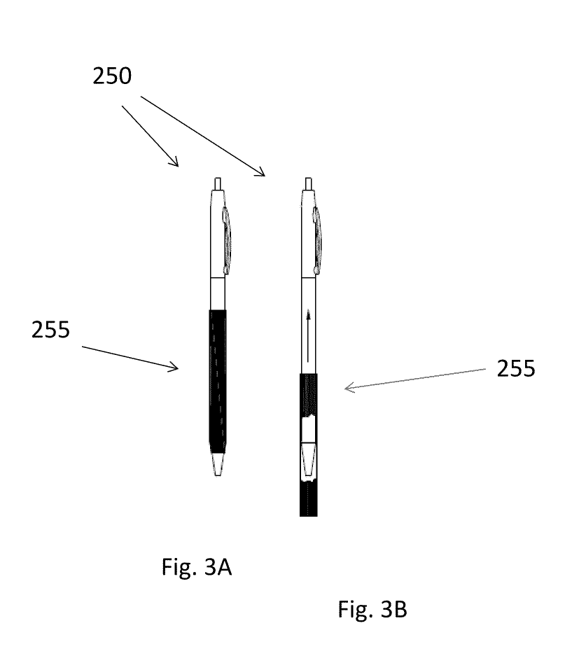

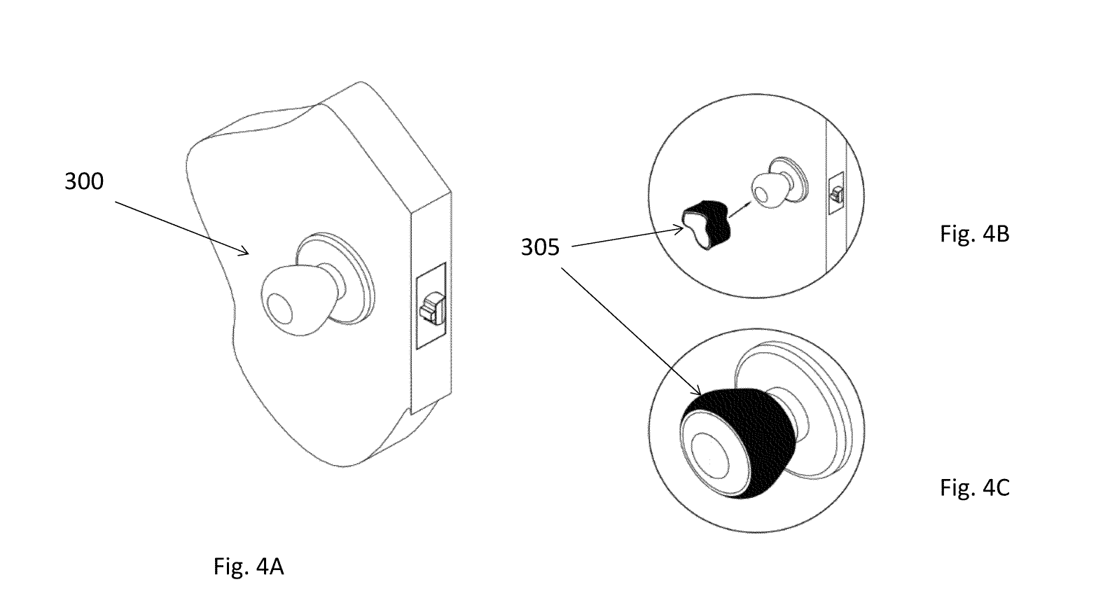

FIGS. 3A and 3B show a sleeve 255 configured to fit on a pen 250. As shown, the sleeve 255 is configured to slide onto the pen 250 (see FIG. 4B). The sleeve 255 may cover the entire length of the pen 250 or the lower portion which is most commonly handled.

FIG. 4A shows a common door knob 300. FIG. 4B shows a door knob sleeve 305 separate from the door knob 300 while FIG. 4C shows the door knob sleeve 305 on the door knob 300. In one embodiment, the door knob sleeve 305 is fabricated of an elastic material impregnated with anti-microbial chemicals known to repel microorganisms including bacteria, viruses, fungi and algae.

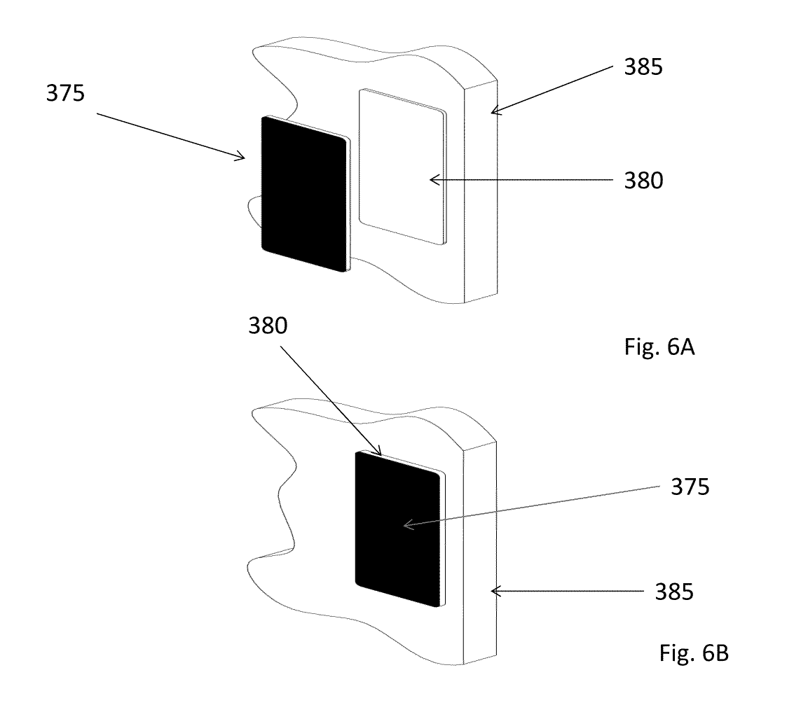

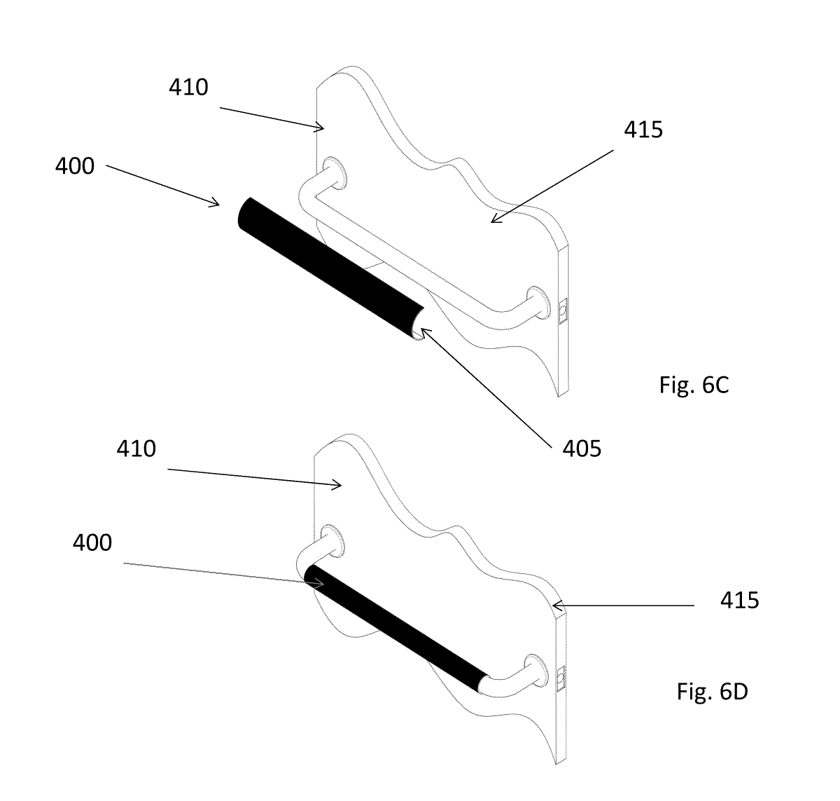

FIGS. 6A-6D show door pushes according to the embodiments of the present invention. FIGS. 6A and 6B show a door push cover 375. As shown, the door push cover 375 is rectangular and configured to fit over a similarly-shaped door push 380 on door 385. The door push cover 375 may be held in place by adhesives, hook and loop fasteners or other attachment means. FIGS. 6C and 6D show a tubular door push cover 400. As shown, the tubular door push cover 400 is C-shaped having an open slit 405 (open tube) along its length allowing it to fit over the door push 410 on door 415. Alternatively, a closed door push cover can be placed on the door push 410 when it is fabricated or at least prior to completion.

In another embodiment, a fabric-based item, such as a tablecloth, is fabricated of threads coated and/or impregnated with anti-microbial chemicals and/or compounds. The resultant tablecloth is therefore resistant to the transfer of bacteria and the like. If impregnated, the anti-microbial chemicals and/or compounds may have a longer life cycle.

During the fabrication of the plastic-type material (or other material such as elastic, rubber, composite, etc.) an anti-microbial chemical is added resulting in a final sleeve, menu, tablecloth or the like having the following properties: (i) water resistant; (ii) flexible and (iii) microorganism resistant. A cover may be made and placed over a natural textured menu or the anti-microbial chemical and/or compounds may be impregnated or integrated with the natural textured material.

Utilizing anti-microbial plastic type material impregnated with anti-microbial chemicals and/or compounds for sleeves, menus and/or tablecloths decreases or prevents the passage of microorganisms from one patron or diner to another. In another embodiment, a plastic-type menu or other item may be dipped into, and thereby coated with, an anti-microbial chemical and/or compound. An anti-microbial wrap around product label may also be utilized in lieu of the sleeve.

In one embodiment, the articles, and others fabricated according to the embodiments of the present invention are branded to make it immediately known to users that the articles have the anti-microbial properties.

Although the invention has been described in detail with reference to several embodiments, additional variations and modifications exist within the scope and spirit of the invention as described and defined in the following claims.

I claim:

1. A sleeve comprising:
a tubular member configured to fit over and secure to an article; and
wherein said tubular member is fabricated of a material having anti-microbial properties.

2. The sleeve of claim 1 wherein said material is a combination of one or more of the following:
polyester, silicon elastomers, PVC, plastic, composite, elastic and rubber.

3. The sleeve of claim 1 wherein said tubular member is closed and configured to fit over and frictionally secure to at least one of the following: (i) condiment container; (ii) pen; (iii) chair arm; (iv) door knob; (v) menu and (vi) door push.

4. The sleeve of claim 1 wherein said tubular member is open and configured to fit over and secure to at least one of the following: (i) condiment container; (ii) pen; (iii) chair arm; (iv) door knob; (v) menu and (vi) door push.

5. The sleeve of claim 1 wherein said material is impregnated with anti-microbial chemicals and/or compounds.

6. A menu comprising:
an article depicting menu items; and
wherein said article is fabricated of at least partially a material having anti-microbial properties.

7. The menu of claim 6 wherein said menu is single page style.

8. The menu of claim 6 wherein said menu is in booklet form.

9. The menu of claim 6 wherein said material is a combination of one or more of the following: polyester, silicon elastomers, PVC, plastic, composite, elastic and rubber.

10. The menu of claim 6 wherein said material is impregnated with anti-microbial chemicals and/or compounds.

11. A table cloth comprising:
a piece of material configured to cover a table top; and
wherein said material includes fibers having anti-microbial properties impregnated with anti-microbial chemicals and/or compounds.

12. The menu of claim 11 wherein said material is a combination of one or more of the following: polyester, silicon elastomers, PVC, plastic, composite, elastic and rubber.

13. The menu of claim 6 wherein said material is impregnated with anti-microbial chemicals and/or compounds.

14. A method making a sleeve comprising:
impregnating a material with one or more anti-microbial chemicals and/or compounds resulting in a material having the following properties: (i) water resistant; (ii) flexible and (iii) microorganism resistant; and
utilizing said resultant material to form a sleeve dimensioned to fit over a subject article.

15. The method of claim 14 wherein said subject article is one of the following: (i) condiment container; (ii) pen; (iii) chair arm; (iv) door knob and (v) menu.

16. The method of claim 14 further comprising impregnating a material having of one or more of the following: polyester, silicon elastomers, PVC, plastic, composite, elastic and rubber.

17. A method making a menu comprising:
impregnating a material with one or more anti-microbial chemicals and/or compounds resulting in a material having the following properties: (i) water resistant; (ii) flexible and (iii) microorganism resistant; and
utilizing said resultant material to form a single page or multiple page menu.

18. The method of claim 17 further comprising impregnating a material having of one or more of the following: polyester, silicon elastomers, PVC, plastic, composite, elastic and rubber.

19. A method making a table cloth comprising:
impregnating fibers of a material with one or more anti-microbial chemicals and/or compounds resulting in a material having the following properties: (i) water resistant; (ii) flexible and (iii) microorganism resistant; and
utilizing said resultant material to form a table cloth.
